(19) United States
(12) Patent Application Publication
(10) Pub. No.: US 2026/0067755 A1
(43) Pub. Date: Mar. 5, 2026

(54) METHOD AND APPARATUS FOR SUBBAND FULL DUPLEXING IN MOBILE WIRELESS COMMUNICATION SYSTEM

(71) Applicants: Soenghun Kim, Hanam-si (KR); BLACKPIN INC., Seoul (KR)

(72) Inventor: Soenghun Kim, Hanam-si (KR)

(21) Appl. No.: 19/286,962

(22) Filed: Jul. 31, 2025

(30) Foreign Application Priority Data
Aug. 29, 2024 (KR) 10-2024-011649

(51) Int. Cl. H04W 36/00; H04L 5/00; H04W 24/10

(52) U.S. Cl. CPC H04W 36/0016; H04L 5/0048; H04W 24/10

(57) ABSTRACT

A method for event-based CSI reporting is provided. The method includes receiving from base station RRCReconfiguration message that comprises various parameters for LTM such as LTM event configurations; evaluating whether LTM event is triggered; initiating LTM measurement reporting procedure if LTM event is triggered; transmitting LTM MR MAC CE for initial reporting; and transmitting periodically LTM MR MAC CEs for subsequent reporting. Subsequent reporting is performed periodically.

### CROSS-REFERENCE TO RELATED APPLICATION

This application claims priority to and the benefit of Korean Patent Application No. 10-2024-0116496, filed on Aug. 29, 2024, the disclosure of which is incorporated herein by reference in its entirety.

### BACKGROUND

### Technical Field

The present disclosure relates to event-based channel state information reporting in a wireless mobile communication system.

### Related Art

To meet the increasing demand for wireless data traffic since the commercialization of 4th generation (4G communication systems), the 5th generation (5G system) is being developed. 5G system introduced millimeter wave (mmW) frequency bands (e.g. 60 GHz bands). In order to increase the propagation distance by mitigating propagation loss in the 5G communication system, various techniques are introduced such as beamforming, massive multiple-input multiple output (MIMO), full dimensional MIMO (FD-MIMO), array antenna, analog beamforming, and large-scale antenna. In addition, base station is divided into a central unit and plurality of distribute units for better scalability. To facilitate introduction of various services, 5G communication system targets supporting higher data rate and smaller latency.

When the UE passes from the coverage area of one cell to another cell, at some point a serving cell change need to be performed. Currently serving cell change is triggered by L3 measurements and is done by RRC signalling triggered Reconfiguration with Synch for change of PCell and PSCell, as well as release add for SCells when applicable, all cases with complete L2 (and L1) resets, and involving more latency, more overhead and more interruption time than beam switch mobility.

To meet the strict service requirements for the future mobile communication system, new mobility mechanism with less interruption time is required.

### SUMMARY

Aspects of the present disclosure are to address the problems of CSI reporting in conjunction with LTM operation. The method of the terminal includes receiving from base station RRCReconfiguration message that comprises various parameters for LTM such as LTM event configurations; evaluating whether LTM event is triggered; initiating LTM measurement reporting procedure if LTM event is triggered; transmitting LTM MR MAC CE for initial reporting; and transmitting periodically LTM MR MAC CEs for subsequent reporting. Subsequent reporting is performed periodically.

### BRIEF DESCRIPTION OF THE DRAWINGS

FIG. 1 is a diagram illustrating the architecture of an 5G system and a NG-RAN to which the disclosure may be applied.

FIG. 2 is a diagram illustrating a wireless protocol architecture in an 5G system to which the disclosure may be applied.

FIG. 3 is a diagram illustrating L1/L2 triggered mobility procedure.

FIG. 4 is a diagram illustrating asynchronous reconfiguration and synchronous reconfiguration.

FIG. 5 is a diagram illustrating CSI reporting.

FIG. 6 is a diagram illustrating signaling structure of RRC reconfiguration message.

FIG. 7 is a diagram illustrating an example of configurations for CSI reporting.

FIG. 8 is a diagram illustrating an example of configurations for LTM CSI reporting.

FIG. 9 is a diagram illustrating CSI report contents.

FIG. 10 is a diagram illustrating an example of mapping between CSI resource and SSBRI.

FIG. 11 is a diagram illustrating an example of CSI report contents.

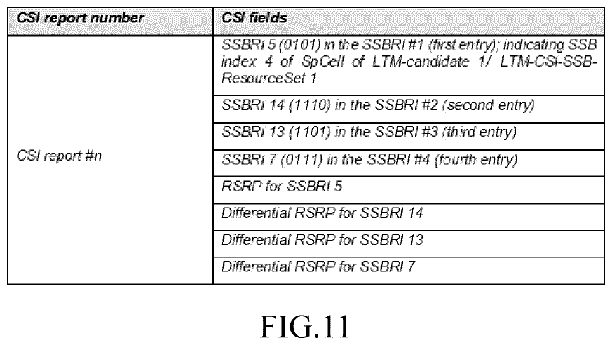

FIG. 12 illustrates format of MAC CE for CSI reporting.

FIG. 13 illustrates format of MAC PDU and subheader.

FIG. 14 illustrates measurement reporting operations of UE and base station.

FIG. 15 illustrates format of LTM MR MAC CE.

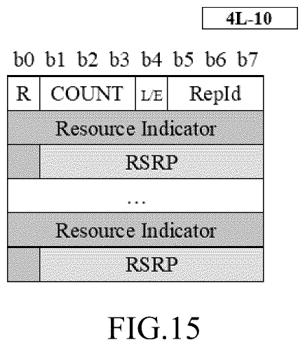

FIG. 16 is a flow diagram illustrating an operation of a terminal.

FIG. 17 is a block diagram illustrating the internal structure of a terminal.

FIG. 18 is a block diagram illustrating the configuration of a base station.

### DETAILED DESCRIPTION

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, followings are used interchangeably:
L2SR and LTM cell switch;
L3SR and handover;
SP CSI reporting on PUCCH Activation/Deactivation MAC CE and CSI report MAC CE;
LTM SP CSI reporting on PUCCH Activation/Deactivation MAC CE and LTM CSI report MAC CE;
P CSI and periodic CSI;
SP CSI and Semi persistent CSI;

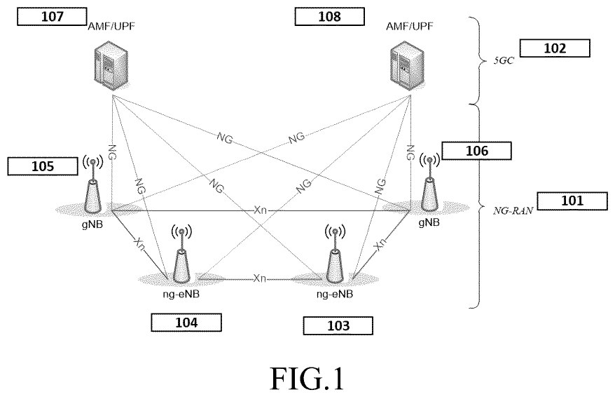

FIG. 1 is a diagram illustrating the architecture of an 5G system and a NG-RAN to which the disclosure may be applied.

5G system consists of NG-RAN 101 and 5GC 102. An NG-RAN node is either:
a GNB, providing NR user plane and control plane protocol terminations towards the UE; or
an ng-eNB, providing E-UTRA user plane and control plane protocol terminations towards the UE.

The GNBs 105 or 106 and ng-eNBs 103 or 104 are interconnected with each other by means of the Xn interface. The GNBs and ng-eNBs are also connected by means of the NG interfaces to the 5GC, more specifically to the AMF (Access and Mobility Management Function) and to the UPF (User Plane Function). AMF 107 and UPF 108 may be realized as a physical node or as separate physical nodes.

A GNB 105 or 106 or an ng-eNBs 103 or 104 hosts the functions listed below.

Functions for Radio Resource Management such as Radio Bearer Control, Radio Admission Control, Connection Mobility Control, Dynamic allocation of resources to UEs in uplink, downlink and sidelink (scheduling); and
IP and Ethernet header compression, uplink data decompression and encryption of user data stream; and
Selection of an AMF at UE attachment when no routing to an MME can be determined from the information provided by the UE; and
Routing of User Plane data towards UPF; and
Scheduling and transmission of paging messages; and
Scheduling and transmission of broadcast information (originated from the AMF or O&M); and
Measurement and measurement reporting configuration for mobility and scheduling; and
Session Management; and
QoS Flow management and mapping to data radio bearers; and
Support of UEs in RRC_INACTIVE state; and
Radio access network sharing; and
Tight interworking between NR and E-UTRA; and
Support of Network Slicing.

The AMF 107 hosts the functions such as NAS signaling, NAS signaling security, AS security control, SMF selection, Authentication, Mobility management and positioning management.

The UPF 108 hosts the functions such as packet routing and forwarding, transport level packet marking in the uplink, QoS handling and the downlink, mobility anchoring for mobility etc.

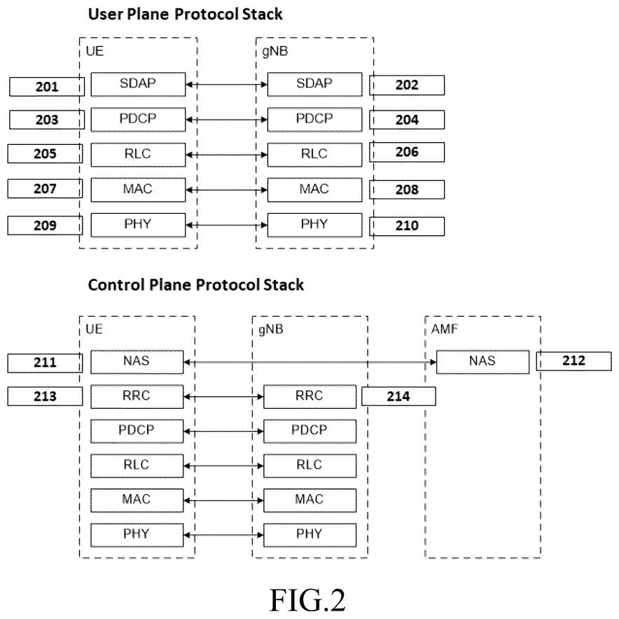

FIG. 2 is a diagram illustrating a wireless protocol architecture in an 5G system to which the disclosure may be applied.

User plane protocol stack consists of SDAP 201 or 202, PDCP 203 or 204, RLC 205 or 206, MAC 207 or 208 and PHY 209 or 210. Control plane protocol stack consists of NAS 211 or 212, RRC 213 or 214, PDCP, RLC, MAC and PHY.

Each protocol sublayer performs functions related to the operations listed below.
NAS: authentication, mobility management, security control etc.
RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.
SDAP: Mapping between a QoS flow and a data radio bearer, Marking QoS flow ID (QFI) in both DL and UL packets.
PDCP: Transfer of data, Header compression and decompression, Ciphering and deciphering, Integrity protection and integrity verification, Duplication, Reordering and in-order delivery, Out-of-order delivery etc.
RLC: Transfer of upper layer PDUs, Error Correction through ARQ, Segmentation and re-segmentation of RLC SDUs, Reassembly of SDU, RLC re-establishment etc.
MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.
PHY: Channel coding, Physical-layer hybrid-ARQ processing, Rate matching, Scrambling, Modulation, Layer mapping, Downlink Control Information, Uplink Control Information etc.

Mobility is a key feature in mobile communications system. Conventional mobility feature relies on L3 measurements and L3 signaling, which may incur long delay and service interruption. To meet the strict service requirements for the future mobile communication system, L1/L2 Triggered Mobility (LTM) is introduced.

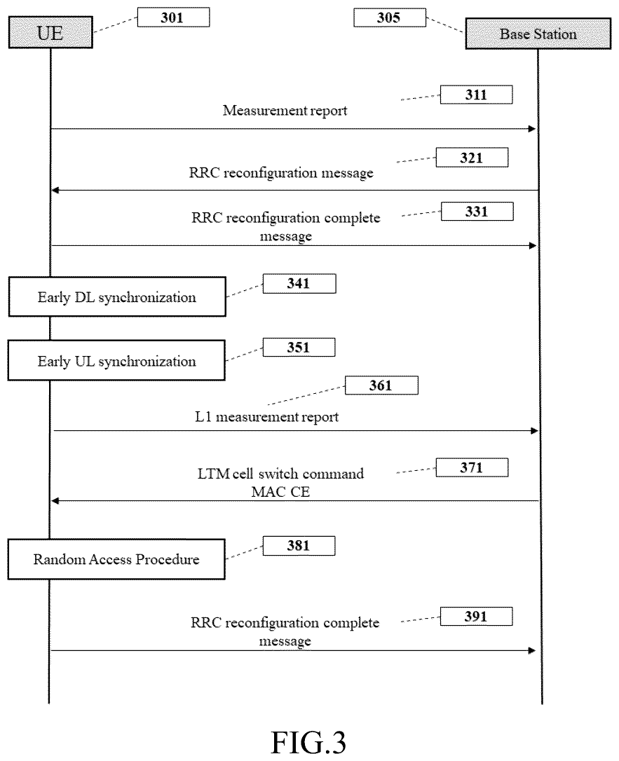

FIG. 3 illustrates the overall procedure for LTM.

LTM is a procedure in which a GNB receives L1 measurement report (e.g. LTM CSI report) from a UE, and on their basis the GNB changes UE serving cell by a cell switch command signalled via a MAC CE. The cell switch command indicates an LTM candidate configuration that the GNB previously prepared and provided to the UE through RRC signalling. Then the UE switches to the target configuration according to the cell switch command.

The UE sends a MeasurementReport message to the GNB. The GNB decides to configure LTM and initiates LTM preparation 311.

The GNB transmits an RRCReconfiguration message to the UE including the LTM candidate configurations 321.

The UE stores the LTM candidate configurations and transmits an RRCReconfigurationComplete message to the GNB 331.

The UE performs early DL synchronization with the LTM candidate cell(s) before receiving the cell switch command 341. The UE may activate and deactivate TCI states of LTM candidate cell(s), as triggered by the GNB. For this operation, type 2 type 2 TCI state activation/deactivation MAC CE is used. Apart from the early DL synchronization with the LTM candidate cell, GNB may use type 1 TCI state activation/deactivation MAC CE to active TCI states of serving cells.

The UE may perform early UL synchronization with LTM candidate cell(s) 351 before receiving the cell switch command, by using UE-based TA measurement, if configured, and/or by transmitting a preamble towards the candidate cell, as triggered by the GNB. UE performs early TA acquisition with the candidate cell(s) as requested by the network before receiving the cell switch command.

The UE performs L1 measurements on the configured LTM candidate cell(s) and transmits L1 measurement reports (LTM CSI report) to the GNB 361.

The GNB decides to execute cell switch to a target cell and transmits an LTM cell switch command MAC CE 371 triggering cell switch by including a target configuration ID which indicates the index of the candidate configuration of the target cell, a beam indicated with a TCI state or beams indicated with DL and UL TCI states, and a timing advance command for the target cell. The UE switches to the target cell and applies the candidate configuration indicated by the target configuration ID.

The UE performs the random access procedure towards the target cell 381, if UE does not have valid TA of the target cell.

The UE completes the LTM cell switch procedure by sending RRCReconfigurationComplete message to target cell 391.

RRC reconfiguration procedure is used for mobility purpose, the procedure should be synchronous between the UE and the base station. In that sense, RRC reconfiguration for mobility purpose could be denoted as synchronous reconfiguration. When the reconfiguration for mobility is triggered by a layer 3 control message (e.g., RRC message), the reconfiguration is denoted as layer 3 triggered synchronous reconfiguration (L3SR) or as layer 3 triggered reconfiguration for mobility (e.g., L3RM). When the reconfiguration for mobility is triggered by a layer 2 control message (e.g., MAC CE), the reconfiguration is denoted as layer 2 triggered synchronous reconfiguration (L2SR) or as layer 2 triggered reconfiguration for mobility (e.g., L2RM).

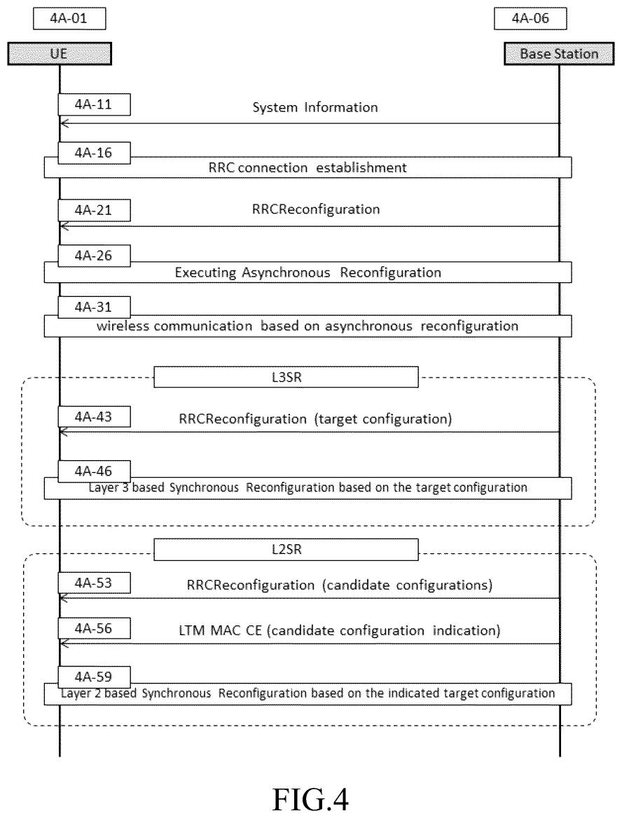

FIG. 4 illustrates the operation of a UE and a base station.

The UE 4A-01 is camping on a cell which is controlled by a base station 4A-06.

At 4A-11, UE receives system information from the base station. The system information includes ServingCellConfigCommonSIB to be applied by the UE in the cell.

At 4A-16, UE performs RRC connection establishment procedure with a base station based on the parameters contained in the ServingCellConfigCommonSIB. UE and the base station establish SRB1 during the RRC connection establishment procedure. The cell becomes SpCell of the UE after RRC connection establishment procedure.

In the RRC connection establishment procedure, UE receives from the base station a RRCSetup. The RRCSetup includes ServingCellConfig to be applied by the UE in the CELL1. The RRRCSetup includes RadioBearerConfig for SRB1.

After SRB1 establishment, UE may report its capability to the base station. The base station may decide the configuration to be applied to the UE based on the UE capability and traffic load status and traffic requirement. UE may report in which frequency bands the UE supports L3SR. UE may report in which frequency bands UE supports L2SR.

RRC connection establishment procedure is performed along with random access procedure.

At 4A-21, The base station transmits a first RRCReconfiguration to the UE. The first RRCReconfiguration may include at least following IEs/fields:
ServingCellConfig (or one or more fields contained in the IE); this IE, if included, replaces ServingCellConfig (or one or more field contained in the IE) received in RRCSetup;
RadioBearerConfig; the UE and base station establishes SRB2 and SRB4 based on this IE; the UE and the base station establishes one or more DRBs based on this IE.

At 4A-26, UE and the base station perform/execute asynchronous reconfiguration procedure based on the configuration information included in the first RRCReconfiguration.

UE and base station determine to perform asynchronous reconfiguration procedure if the corresponding RRCReconfiguration does not include Reconfugration WithSync IE.

UE applies the configuration information in the first RRCReconfiguration at time_point_1 and the base station applies the configuration information at time_point_2. The time_point_1 is when UE decodes the configuration information. The time_point_2 is when the base station considers transmission of the RRCReconfiguration containing the configuration information is successful 1 (e.g. when HARQ ACK for the RRCReconfiguration is received).

After completion of the asynchronous reconfiguration procedure, UE and the base station perform wireless communication based on the following configuration 4A-31:
ServingCellConfigCommonSIB (e.g. broadcasted common serving cell configuration) received in the SIBI of the SpCell (if ServingCellConfigCommon is not provided in RRCSetup) or ServingCellConfigCommon (e.g. dedicatedly delivered common serving cell configuration) in RRCSetup (if ServingCellConfigCommon is provided in RRCSetup);
ServingCellConfig (e.g. dedicate serving cell configuration) received in the RRCSetup (if the first RRCReconfgiration does not include ServingCellConfig) or in the first RRCReconfiguration (if the first RRCReconfiguration includes ServingCellConfig);
RadioBearConfig (e.g. radio bearer configuration) received in the first RRCReconfiguration (for SRB2 and SRB4) or RadioBearerConfig receive in the RRCSetup (SRB1);
UE performs following operation based on ServingCellConfigCommonSIB received in the SIBI of the SpCell:
initial BWP determination based on downlinkConfigCommon and uplinkConfigCommon;
contention based random access procedure in the initial BWP based on RACH-ConfigCommon (e.g. common RACH configuration);
uplink timing alignment based on n-TimingAdvanceOffset;
UE performs following operations based on ServingCellConfig received in the RRCSetup or in the first RRCReconfiguration:
BWP switching based on one or more BWP configuration information;
CSI reporting based on CSI-ReportConfig;
Scheduling Request based on SchedulingRequestReourceConfig;
SRS transmission based on SRS-Config;
TimeAlignmentTImer maintenance (e.g. setting the value of the timer) based on timeAlignmentTimer field for TAG 0
UE performs following operations based on RadioBearConfig received in the first RRCReconfiguration;
RRC message transmission and reception via SRB1 based on SRBToAddMod in RRCSetup;
RRC message transmission and reception via SRB2 and or SRB4 based on SRBToAddMod IEs in the first RRCReconfiguration;
IP packet transmission and reception via DRBs based on DRBToAddMod IEs in the first RRCReconfiguration.

To support UE mobility, the base station may determine to perform either L2SR or L3SR.

If the base station determines to apply L3SR, the base station and the UE perform 4A-43 and 4A-46.

If the base station determines to apply L2SR, the base station and the UE perform 4A-53 and 4A-56 and 4A-59.

For L3SR, the base station transmits to the UE a second RRCReconfiguration 4A-43.

The second RRCReconfiguration comprises Reconfiguration WithSync IE that contains common serving cell configuration for the target SpCell. The second RRCReconfiguration comprises various configurations such as RadioBeearConfig if the configurations are required to be updated.

The UE and the base station perform L3SR based on the target configuration contained in the second RRCReconfiguration 4A-46.

When the L3SR is triggered: UE performs configurations based on the target configurations contained in the second RRCReconfiguration; UE sets the contents of RRCReconfigurationComplete based on the contents of the second RRCReconfiguration; and UE transmits the RRCReconfigurationComplete in the target cell.

The configuration information such as Reconfiguration WithSync comprises various information for the target SpCell. The UE performs downlink synchronization for the target SpCell.

To transmit the RRCReconfigurationComplete, the UE initiates random access procedure in the target SpCell.

When the random access procedure triggered for RRCReconfigurationComplete is successfully completed, the UE and the base station consider the L3SR is successfully completed.

For L2SR, the base station transmits to the UE a third RRCReconfiguration 4A-53.

The third RRCReconfiguration comprises LTM-Config IE that contains a reference configuration and one or more candidate configurations.

The reference configuration comprises an embedded RRCReconfiguration.

Each candidate configuration comprises an embedded RRCReconfiguration. Each candidate configuration is associated with an identifier (e.g. candidateId).

The embedded RRCReconfiguration of each candidate configuration contains delta configuration over the embedded RRCReconfiguration of the reference configuration.

The UE generates a complete/target/final candidate configuration for a candidate by combining the embedded RRCReconfiugration of the candidate configuration with the embedded RRCReconfiguration of the reference configuration. More specifically, the UE determines IE X (of field x) of the candidate configuration is the IE X of the final candidate configuration in case that:
the IE X is present both in the candidate configuration and the reference configuration; or
the IE X is present only in the candidate configuration.

UE determines IE Y (or field y) of the reference configuration as the IE Y of the final candidate configuration in case that the IE Y is present only in the reference configuration.

Based on the layer 1 measurements (e.g. LTM CSI measurement and LTM CSI report), the base station may determine that cell switch is required for the UE.

The base station transmits UE LTM MAC CE 4A-56.

The UE and the base station perform L2SR based on the final candidate configuration indicated in the LTM MAC CE 4A-59.

When the L2SR is triggered: UE performs configurations based on the stored final configuration indicated by the MAC CE; UE sets the contents of RRCReconfigurationComplete based on the contents of the embedded RRCReconfiguration of the candidate configuration indicated by the MAC CE; and UE transmits the RRCReconfigurationComplete in the target SpCell of the candidate configuration.

The configuration information such as switch_info comprises various information for the target SpCell. The UE performs downlink synchronization for the target SpCell.

To transmit the RRCReconfigurationComplete, the UE may either initiate random access procedure in the target SpCell or monitor PDCCH to acquire uplink grant or use configured grant (if configured).

The UE and the base station consider the L2SR is successfully completed, when:
the random access procedure triggered for RRCReconfigurationComplete is successfully completed; or
uplink grant for new transmission is received after transmission of the RRCReconfigurationComplete.

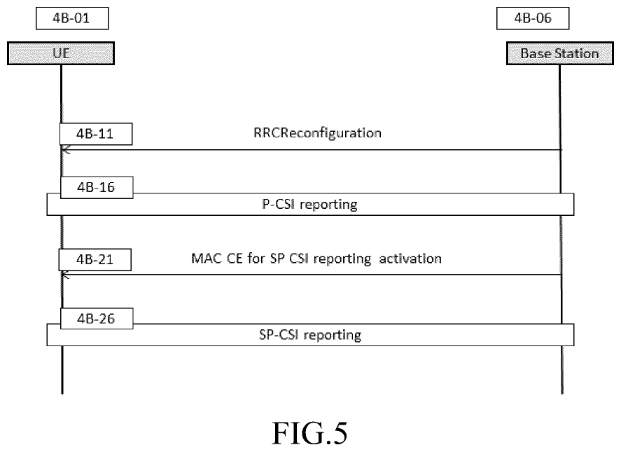

FIG. 5 illustrates operations for CSI reporting.

Current Serving/active Cell Group comprises Serving/active SpCell and Serving/active SCell. Candidate Cell Group comprises candidate SpCell and candidate SCell.

UE receives from the base station a RRCReconfiguration message 4B-11. The RRCReconfiguration message may contain followings:
configuration parameters for a current serving cell group in a CellGroupConfig; and
configuration parameters for cell groups of LTM candidates (e.g., one or more LTM-candidate) in a LTM-Config;
UE performs followings based on the RRCReconfiguration message 4B-16:
periodic CSI reporting for serving cells (e.g., Non-LTM-CSI-reporting); and/or
periodic CSI reporting for candidate SpCells (e.g., LTM-CSI-reporting).

UE receives from the base station a MAC CE for SP CSI reporting activation 4B-21.

UE performs followings based on the MAC CE for SP CSI reporting activation 4B-26.
SP CSI reporting on PUCCH for current serving/active cell group; or
LTM SP CSI reporting on PUCCH for candidate SpCell(s).

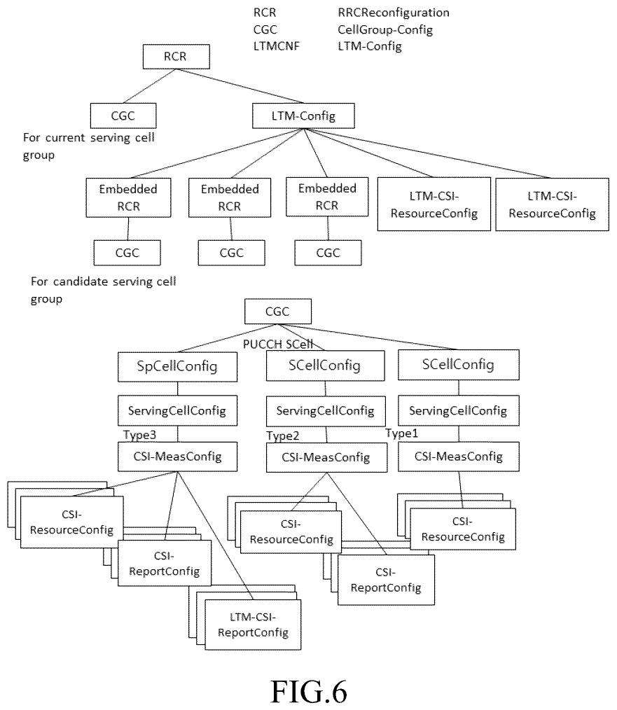

The RRCReconfiguration message is the command to modify an RRC connection. An example of signaling structure of the RRCReconfiguration message is illustrated in FIG. 6.

The RRCReconfiguration message may comprise a cell group configuration (CGC) for current serving cell group and LTM configuration (LTM-Config) carrying various configuration information for LTM operation.

The LTM-Config may comprise followings:
one or more embedded RRCReconfiguration messages, wherein each of the embedded RRCReconfiguration message comprises a cell group configuration for candidate cell group;
one or more LTM-CSI-Resource configuration (list of LTM-CSI-ResourceConfig).

Base station needs to known channel state of the UE to perform scheduling or LTM operation. For scheduling purpose, the base station receives from the UE CSI report that carries channel state of serving cells of the current active cell group. For LTM purpose, the base station receives from the UE CSI report that carries channel state of candidate cells of candidate cell groups.

CSI resource is set of reference signals that are to be measured for channel state determination. For scheduling-oriented CSI reporting, UE measures CSI resource associated with current SpCell and current SCells. Based on the reported channel states, base station make proper decision on how much data is to be transmitted in which serving cell. CSI resource configuration for a serving cell and CSI report configuration for a serving cell are configured by CSI measurement configuration (CSI-MeasConfig) of the serving cell of the current active cell group.

CSI resource configuration comprises set of parameters that configures CSI-RSs that are associated with each serving cell. CSI report configuration comprises set of parameters that configures PUCCH resource for CSI reporting and indicates which CSI-RS is to be reported in the PUCCH resource.

CSI reporting is either periodic or semi-persistent. For periodic CSI reporting, UE starts CSI reporting when periodic CSI reporting is configured by CSI-MeasConfig in the RRCReconfiguration message. For semi-persistent CSI reporting, UE starts CSI reporting when a specific MAC CE is received.

For LTM-oriented CSI reporting, UE measures CSI resource associated with candidate SpCells. Based on the reported channel states, base station makes proper decision on whether to command cell switch and to which candidate SpCell. CSI resource configurations for LTM CSI reporting is not specific to a cell group but rather across cell groups. In that sense LTM CSI resource configuration is better put into a place that is independent from candidate cell groups. On the other hand, LTM CSI reporting configuration comprises set of parameters that configures PUCCH resource, wherein PUCCH resource is SpCell specific. Hence unlink LTM CSI resource configuration, LTM CSI reporting configuration should be placed under the configuration information of each SpCell.

Each cell group configuration comprises SpCell configuration and one or more SCell configurations. Both SpCell configuration and SCell configuartion comprise serving cell configuration (ServingCellConfig), which comprises CSI measurement configuration.

A CSI measurement configuration (CSI-MeasConfig) may comprise:
one or more CSI-ResourceConfig, wherein each comprises set of parameters for CSI resource for non-LTM CSI reporting;
one or more CSI-ReportConfig, wherein each comprises set of parameters for non-LTM CSI reporting configuration;
one or more LTM-CSI-ReportConfig, wherein each comprises set of parameters for LTM reporting configuration.

Depending on type of serving cell, corresponding CSI-MeasConfig may comprise different components. For the discussion, followings are defined:
Type 1 CSI-MeasConfig comprises one or more CSI-ResourceConfig;
Type 2 CSI-MeasConfig comprises one or more CSI-ResourceConfig and one or more CSI-ReportConfig;
Type 3 CSI-MeasCofnig comprises one or more CSI-ResourceConfig and one or more CSI-ReportConfig and one or more LTM-CSI-ReportConfig.

For SpCell, since non-LTM CSI reporting and LTM CSI reporting are required, type 3 CSI-MeasConfig is applied.

For PUCCH SCell, since non-LTM CSI reporting is required, type 2 CSI-MeasConfig is applied.

For other SCell, since CSI reporting is not performed, type 1 CSI-MeasConfig is applied.

A SCell configured with a type 1 CSI-MeasConfig provides the reference signal (CSI resources) for non-LTM CSI reporting.

A PUCCH SCell configured with a type 2 CSI-MeasConfig provides the reference signal (CSI resources) for non-LTM CSI reporting and the PUCCH resource for non-LTM CSI reporting.

A SpCell configured with a type 3 CSI-MeasConfig provide the reference signal (CSI resources) for non-LTM CSI reporting and the PUCCH resource for non-LTM CSI reporting and the reference signal (LTM-CSI resource) for LTM CSI reporting and the PUCCH resource for LTM CSI reporting.

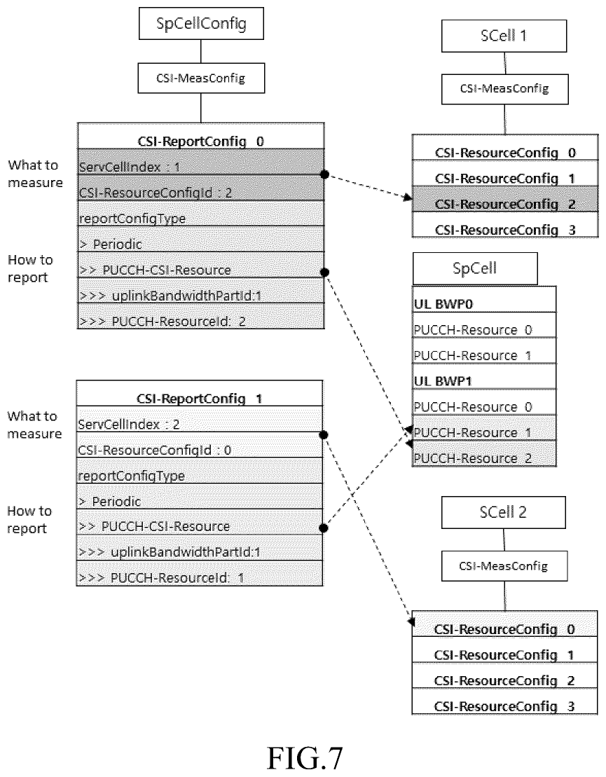

FIG. 7 illustrates an example of non-LTM CSI reporting.

Assuming CSI-ReportConfig 0 and CSI-ReportConfig 1 are comprised in CSI-MeasConfig of SpCellConfg, UE performs periodic CSI reporting based on the CSI-ReportConfig 0 and CSI-ReportConfig 1. Based on those CSI reporting configurations, UE performs periodic CSI reporting for CSI-ResourceConfig2 of SCell1 on PUCCH-Resource 1 of SpCell. UE also performs periodic CSI reporting for CSI-ResourceConfig0 of SCell2.

UE may measure CSI-resources of a serving cell (e.g. SpCell or SCells) based on CSI-ResourceConfig in the CSI-MeasConfig of the serving cell. UE may report the P-CSI or SP-CSI on PUCCH for the serving cell based on CSI-ReportConfig in the CSI-MeasConfig of SpCell (or PUCCH SCell).

For non-LTM CSI reporting, a P-CSI report or a SP-CSI report on PUCCH may comprise various report quantity for a single serving cell (e.g. various quantity for a single serving cell can be reported in a P-CSI report or a SP-CSI report on PUCCH). The report quantity could be CRI-RI-PMI-CQI or CRI-RI-CQI or CRI-RRP or SSB-INDEX-RSRP or others. Basically, non-LTM CSI reporting can be performed for various types of reference signal (e.g. CSI-RS or SSB). Hence explicit parameter called reportQuantity configures which report quantity to be reported.

On the other hands, it is not useful to configure CSI-RS for LTM CSI reporting. CSI-RS is sharper than SSB which is good for fine scheduling. However, for mobility, wider beam such as SSB is more than enough for most cases. For LTM CSI reporting, reporting quantity is fixed to SSBRI (SSB resource indicator) without explicit parameter.

CSI-ReportConfig indicates what to measure (in ServCellIndex and CSI-ResorceConfigId) and how to report (in PUCCH-CSI-Resource).

For example, UE may report quantity measured on CSI-Resources associated with CSI-ResourceConfig2 of a SCell (ServCellIndex=1) is reported in the PUCCH-Resource (PUCCH-ResourceId=2) of UL BWP 1 of SpCell if one or CSI-ReportConfig in CSI-MeasConfig of the SpCell include followings:
ServCellIndex=1;
CSI-ResourceConfigId=2;
uplinkBandwidthPartId=1; and
PUCCH-ResourceId=2.

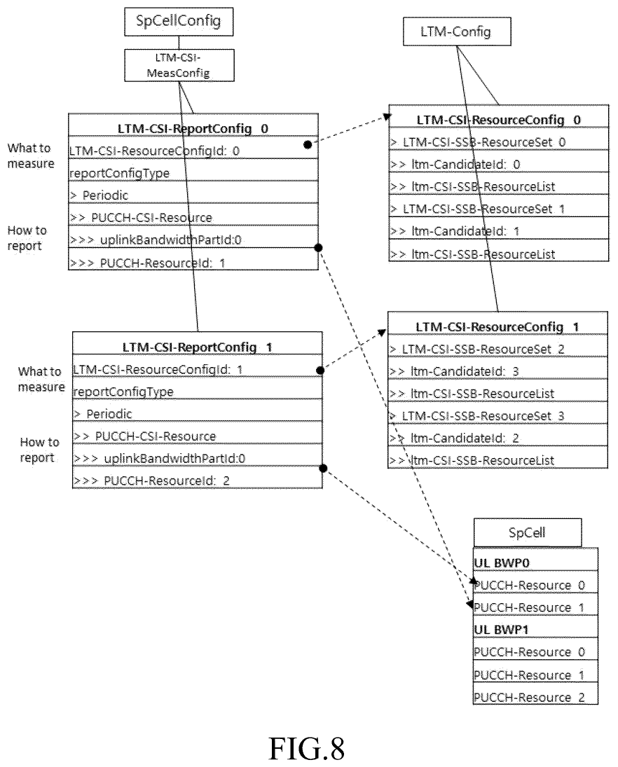

FIG. 8 illustrates an example of LTM CSI reporting.

LTM-CSI-MeasConfig in SpCellConfig comprises LTM-CSI-ReportConfig 0 and LTM-CSI-ReportConfig 1. UE performs periodic LTM CSI reporting on LTM-CSI-ResourceConfig 0 via PUCCH-Resource 1 of UL BWP 0 of SpCell. UE performs periodic LTM CSI reporting on LTM-CSI-ResourceConfig 1 via PUCCH-Resource 0 of UL BWP 0 of SpCell.

UE may measure LTM-CSI-SSB-Resources of one or more candidate SpCells based on LTM-CSI-ResourceConfig in the LTM-Config.

UE may report the P-CSI or SP-CSI on PUCCH for the serving cell based on LTM-CSI-ReportConfig in the CSI-MeasConfig of serving SpCell.

For LTM CSI reporting, a P-CSI report or a SP-CSI report on PUCCH may comprise a single type of report quantity for one or more candidate SpCells. The single type of the report quantity is not configured but fixed. The single type of the report quantity is ssb-Index-RSRP.

LTM-CSI-ReportConfig indicates what to measure (in LTM-CSI-ResourceConfigId) and how to report (in PUCCH-CSI-Resource).

For example, UE may report quantity measured on CSI-SSB-Resources associated with SpCell of LTM-candidate 0 and on CSI-SSB-Resource associated with SpCell of LTM-Candidate 1 via the PUCCH-Resource (PUCCH-ResourceId=1) of UL BWP 0 of SpCell, if one of LTM-CSI-ReportConfig in CSI-MeasConfig of the SpCell include followings:
LTM-CSI-ResourceConfigId=0, wherein LTM-CSI-Resource 0 consists with LTM-CSI-SSB-ResourceList of LTM-candidate 0 and LTM-CSI-SSB-ResourceList of LTM-candidate 1;
uplinkBandwidthPartId=0; and
PUCCH-ResourceId=1.

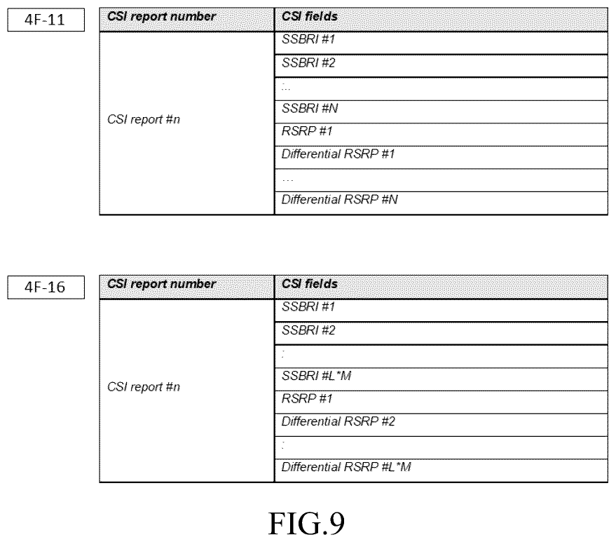

FIG. 9 illustrates an example of LTM CSI report contents.
For non-LTM CSI report (4F-11):
SSBRI #x is the x^{th} entry of CSI report. When SSBRI #x indicates k, it means followings:
If the UE, for a PUCCH SCell or for a SpCell, is configured with a CSI-ReportConfig (within CSI-MeasConfig of the corresponding ServingCellConfig) with the higher layer parameter reportQuantity set to ‘ssb-Index-RSRP’ or ‘ssb-Index-RSRP-Index’, the UE shall report SSBRI, where SSBRI k (k≥0) corresponds to the configured (k+1)^{th} entry of the associated csi-SSB-ResourceList in the corresponding CSI-SSB-ResourceSet.

Number of SSBRI entries in a CSI report is configured within a CSI-ReportConfig (or within CSI-MeasConfig). The size/bitwidth of SSBRI entries in a CSI report is determined implicitly based on the configured number of SS/PBCH blocks (e.g. number of SSB-Index) in the corresponding resource set (CSI-SSB-ResourceSet) such that at least one codeword of the SSBRI can be associated with each SS/PBCH block. For example, if the number of SS/PBCH blocks is 5, the SSBRI is 3 bit (=ceiling [log 25)]. If the number of SS/PBCH blocks is 16, the SSBRI is 4 bit.

Within a LTM-CSI report (4F-16), L cells (each with M beams) are reported.

SSBRI #x is the x^{th} entry of CSI report. When SSBRI #x indicates k, it means followings:
If the UE, for a SpCell, is configured with a LTM-CSI-ReportConfig (within CSI-MeasConfig of the corresponding ServingCellConfig), the UE shall report SSBRI, where SSBRI k (k≥0) corresponds to the configured (k+1)^{th} entry across all ltm-csi-SSB-ResourceLists of the LTM-CSI-SSB-ResourceSets associated with the LTM-CSI-ReportConfig in the ascending/descending order of LTM-CSI-SSB-ResourceSetld. The entries of ltm-csi-SSB-ResourceLists are ordered according to the associated LTM-CSI-SSB-ResourceSetId (e.g. the first entry of the LTM-CSI-SSB-ResourceSet 0 corresponds to SSBRI0, the nth (and last) entry of the LTM-CSI-SSB-ResourceSet 0 corresponds to SSBRI n−1, the first entry of the LTM-CSI-SSB-ResourceSet 1 corresponds to SSBRI n and so on).

For example, When LTM-CSI-ReportConfig is as 4G-11, SSBRI k is mapped with each SSB-Index as 4G-16.

If SSBRI 10 is reported, it means SSB-Index 11 of LTM-CSI-SSB-ResourceSet3 (or SpCell of ltm-Canddidate 4).

Each SSB-Index of each LTM-CSI-SSB-ResourceSet indicates the corresponding SSB of the SpCell of the associated LTM-candidate.

SpCell of a LTM-candidate is the cell associated with SpCellConfig of the embedded RRCReconfiguration of the LTM-candidate.

SSB indexes of the LTM-CSI-ResourceConfig are ordered based on the LTM-CSI-SSB-ResourceSetId first and then SSB-Index next (e.g. SSB-Index x of LTM-CSI-SSB-ResoruceSet n is ordered ahead of SSB-index x+y of LTM-CSI-SSB-ResourceSet m when m>n).

The size/bitwidth of SSBRI entries in a CSI report is determined implicitly based on the total configured number of SS/PBCH blocks (e.g. number of SSB-Index) across all the resource sets (LTM-CSI-SSB-ResourceSets) of the corresponding LTM-CSI-ResourceConfig such that at least one codeword of the SSBRI can be associated with each SS/PBCH block. For example, if the number of SS/PBCH blocks across all resource sets is 15, the SSBRI is 4 bit (=ceiling [log 215)].

UE may determine the number of SSBRIs to be reported based on noOfReportedCells and noOfReportedRS-PerCell in LTM-ReportContent (product of the two parameters).

In the example above, UE selects two LTM-CSI-SSB-ResourceSets (or candidate SpCells) and two SSB-Indexes from each set. The number of SSBRI entries is 4. The number of RSRP entry is 1. The number of differential RSRP entries is 3 (=the number of SSBRI entries−1).

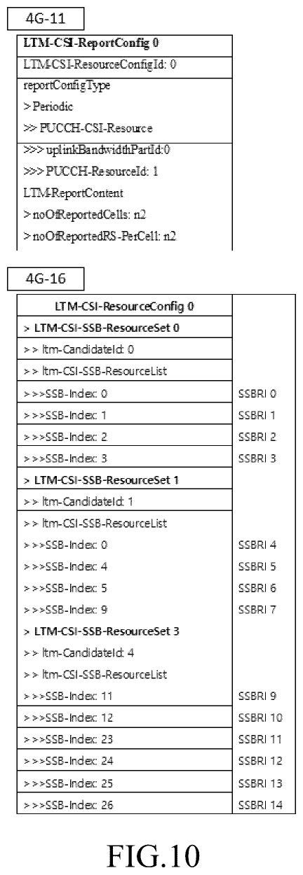

UE includes the selected SSB-indexes in the CSI report as in FIG. 10. lowest RSRP is placed first and highest RSRP is placed last.

To start or stop non-LTM SP CSI reporting:
SP CSI reporting on PUCCH Activation/Deactivation MAC CE is used;
SP CSI reporting on PUCCH Activation/Deactivation MAC CE is applied either to SpCell or to PUCCH SCell;
SP CSI reporting on PUCCH Activation/Deactivation MAC CE is received from any active serving cells; and
UE starts/stops SP CSI reporting on PUCCH of UL BWP x of Serving Cell y corresponding to Si field based on:
   Serving Cell ID field (indicating Serving Cell y);
   BWP ID field (indicating UL BWP x); and
   Si field in the received SP CSI reporting on PUCCH Activation/Deactivation MAC CE.

To start or stop LTM SP CSI reporting:
SP LTM CSI reporting on PUCCH Activation/Deactivation MAC CE is used;
SP LTM CSI reporting on PUCCH Activation/Deactivation MAC CE is applied only to current active SpCell;
SP CSI reporting on PUCCH Activation/Deactivation MAC CE is received from any active serving cells; and
UE starts/stops SP CSI reporting on PUCCH of UL BWP x of SpCell corresponding to msi based on:
   BWP ID field (indicating UL BWP x); and
   mSi field in the received SP CSI reporting on PUCCH Activation/Deactivation MAC CE.

To start or stop non-LTM P CSI reporting:
P CSI reporting on PUCCH Activation/Deactivation RRCReconfiguration (including CSI-MeasConfig within which at least one CSI-ReportConfig with type set to periodic is included) is used;
P CSI reporting on PUCCH Activation/Deactivation RRCReconfiguration is applied either to SpCell or to PUCCH SCell;
P CSI reporting on PUCCH Activation/Deactivation RRCReconfiguration is received from any active serving cells; and
UE starts/stops P CSI reporting based on following parameters in P CSI reporting on PUCCH Activation/Deactivation RRCReconfiguration:
   csi-ReportConfig in csi-ReportConfigToAddModList of which type set to periodic; and
   CSI-ReportConfigId in csi-ReportConfigToReleaseList that is associated with CSI-ReportConfig of which type set to periodic.

To start or stop LTM P CSI reporting:
LTM P CSI reporting on PUCCH Activation/Deactivation RRCReconfiguration (including CSI-MeasConfig within which at least one LTM-CSI-ReportConfig with type set to periodic is included) is used;
LTM P CSI reporting on PUCCH Activation/Deactivation RRCReconfiguration is applied only to current active SpCell;
LTM P CSI reporting on PUCCH Activation/Deactivation RRCReconfiguration is received from any active serving cells; and
UE starts/stops LTM P CSI reporting based on following parameters in LTM P CSI reporting on PUCCH Activation/Deactivation RRCReconfiguration:
   ltm-csi-ReportConfig in csi-ReportConfigToAddModList of which type set to periodic; and
   LTM-CSI-ReportConfigId in ltm-csi-ReportConfigToReleaseList that is associated with LTM-CSI-ReportConfig of which type set to periodic.

UE may:
stop a P-CSI reporting or SP-CSI reporting on PUCCH when the corresponding CSI-ReportConfig is released by a RRC message;
stop a LTM P-CSI reporting or a LTM SP-CSI reporting on PUCCH of a SpCell when the LTM-CSI-ReportConfig of the SpCell is released by a RRC message; and
stop all LTM P-CSI reporting and all LTM SP-CSI reporting on PUCCH when LTM-Config is released by a RRC message.

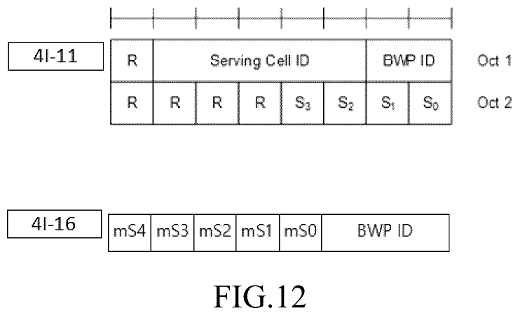

FIG. 12 illustrates format of MAC CE for CSI reporting.

The SP CSI reporting on PUCCH Activation/Deactivation MAC CE (4I-11) is identified by a MAC subheader with LCID. It has a fixed size of 16 bits with following fields:
Serving Cell ID: This field indicates the identity of the Serving Cell for which the MAC CE applies. The length of the field is 5 bits;
BWP ID: This field indicates a UL BWP for which the MAC CE applies as the codepoint of the DCI bandwidth part indicator field. The length of the BWP ID field is 2 bits;
Si: This field indicates the activation/deactivation status of the Semi-Persistent CSI report configuration within csi-ReportConfigToAddModList. S0 refers to the report configuration which includes PUCCH resources for SP CSI reporting in the indicated BWP and has the lowest CSI-ReportConfigId within the list with type set to semiPersistentOnPUCCH, S1 to the report configuration which includes PUCCH resources for SP CSI reporting in the indicated BWP and has the second lowest CSI-ReportConfigId and so on. If the number of report configurations within the list with type set to semiPersistentOnPUCCH in the indicated BWP is less than i+1, MAC entity shall ignore the Si field. The Si field is set to 1 to indicate that the corresponding Semi-Persistent CSI report configuration shall be activated. The Si field is set to 0 to indicate that the corresponding Semi-Persistent CSI report configuration i shall be deactivated;
R: Reserved bit, set to 0.

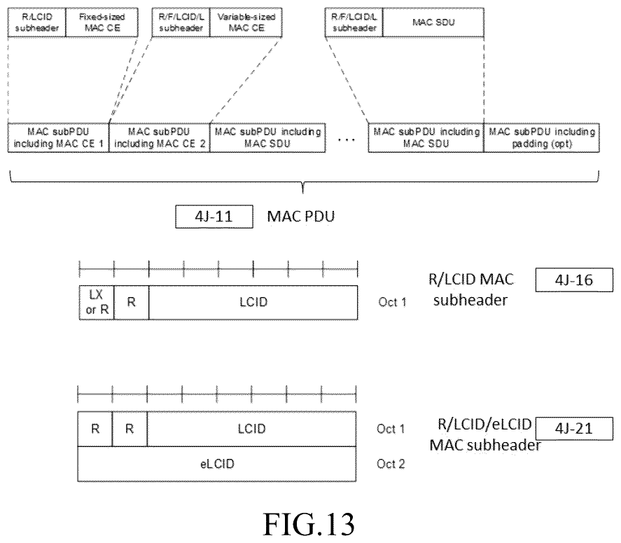

The LTM SP CSI reporting on PUCCH Activation/Deactivation MAC CE (4I-16) is identified by a MAC subheader with eLCID. It has a fixed size of 8 bits (BWP ID 3 bit; mSi 5 bit) with following fields:
mSi: This field indicates the activation/deactivation status of the LTM Semi-Persistent CSI report configuration configured by ltm-CSI-ReportConfigToAddModList and ltm-CSI-ReportConfigToReleaseList in CSI-MeasConfig of the SpCell. mS0 refers to the report configuration which includes PUCCH resources for SP CSI reporting in the indicated BWP and has the lowest ltm-CSI-ReportConfigId within the list with type set to semiPersistentOnPUCCH, mS1 to the report configuration which includes PUCCH resources for SP CSI reporting in the indicated BWP and has the second lowest CSI-ReportConfigId and so on. If the number of report configurations within the list with type set to semiPersistentOnPUCCH in the indicated BWP is less than i+1, MAC entity shall ignore the mSi field. The Si field is set to 1 to indicate that the corresponding Semi-Persistent LTM CSI report configuration shall be activated. The Si field is set to 0 to indicate that the corresponding Semi-Persistent LTM CSI report configuration i shall be deactivated;
BWP ID: This field indicates a UL BWP for which the MAC CE applies as the codepoint of the DCI bandwidth part indicator field. The length of the BWP ID field is 2 bits;
Alternatively, The LTM SP CSI reporting on PUCCH Activation/Deactivation MAC CE is identified by a MAC subheader with eLCID. It has a fixed size of 8 bits (mSi 5 bit; R 3 bit) with following fields:
mSi: This field indicates the activation/deactivation status of the LTM Semi-Persistent CSI report configuration configured by ltm-CSI-ReportConfigToAddModList and ltm-CSI-ReportConfigToReleaseList in CSI-MeasConfig of the SpCell. mS0 refers to the report configuration which includes PUCCH resources for SP CSI reporting in a specific BWP and has the lowest ltm-CSI-ReportConfigId within the list with type set to semiPersistentOnPUCCH, mS1 to the report configuration which includes PUCCH resources for SP CSI reporting in the specific BWP and has the second lowest CSI-ReportConfigId and so on. If the number of report configurations within the list with type set to semiPersistentOnPUCCH in the indicated BWP is less than i+1, MAC entity shall ignore the mSi field. The Si field is set to 1 to indicate that the corresponding Semi-Persistent LTM CSI report configuration shall be activated. The Si field is set to 0 to indicate that the corresponding Semi-Persistent LTM CSI report configuration i shall be deactivated;
The specific BWP is the currently active UL BWP of the current serving SpCell.
FIG. 13 illustrates format of MAC PDU and subheader.

A MAC PDU (4J-11) consists of one or more MAC subPDUs. Each MAC subPDU consists of one of the following:
A MAC subheader only (including padding);
A MAC subheader and a MAC SDU;
A MAC subheader and a MAC CE; or
A MAC subheader and padding.

The MAC SDUs are of variable sizes. Each MAC subheader corresponds to either a MAC SDU, a MAC CE, or padding. A MAC subheader except for fixed sized MAC CE, padding, and a MAC SDU containing UL CCCH consists of the header fields R/F/LCID/(eLCID)/L. A MAC subheader for fixed sized MAC CE and padding consists of the header fields R/LCID/(eLCID). A MAC subheader for a MAC SDU containing UL CCCH consists of the header fields (LX)/R/LCID.

A MAC subheader for SP CSI reporting on PUCCH Activation/Deactivation MAC CE consists of the header fields R/LCID (4J-16). LCID is set to a specific value associated with the MAC CE. A MAC subheader for LTM SP CSI reporting on PUCCH Activation/Deactivation MAC CE consists of the header fields R/LCID/Elcid (4J-21). LCID is set to a specific value indicating that eLCID is following. eLCID is set to a specific value associated with the MAC CE.

The IE CSI-MeasConfig is used to configure CSI-RS (reference signals) belonging to the serving cell in which CSI-MeasConfig is included, channel state information reports to be transmitted on PUCCH on the serving cell in which CSI-MeasConfig is included and channel state information reports on PUSCH triggered by DCI received on the serving cell in which CSI-MeasConfig is included. The CSI-MeasConfig IE comprises following fields: csi-ResourceConfigToAddModList field that comprises a list of CSI-ResourceConfig;
csi-ResourceConfigToReleaseList field that comprises a list of CSI-ResourceConfigIds;
csi-ReportConfigToAddModList field that comprises a list of CSI-ReportConfig;
csi-ReportConfigToReleaseList field that comprises a list of CSI-ReportConfigIds;
ltm-CSI-ReportConfigToAddModList field that comprises a list of LTM-CSI-ReportConfig; and
ltm-CSI-ReportConfigToReleaseList field that comprise a list of LTM-CSI-ReportConfigIds.

The IE CSI-ResourceConfig defines a group of one or more NZP-CSI-RS-ResourceSet, CSI-IM-ResourceSet and/or CSI-SSB-ResourceSet. The CSI-ResourceConfig comprises following fields:
csi-ResourceConfigId field;
nzp-CSI-RS-ResourceSetList field (comprising a list of NZP-CSI-RS-ResourceSetId) or csi-SSB-ResourceSetList (comprising a list of CSI-SSB-ResourceSetId); and
bwp-Id field.

The IE CSI-SSB-ResourceSet is used to configure one SS/PBCH block resource set which refers to SS/PBCH as indicated in ServingCellConfigCommon and ServingCellConfig. The IE CSI-SSB-ResourceSet comprises a list of SSB-Index.

The IE CSI-ReportConfig is used to configure a periodic or semi-persistent report sent on PUCCH on the cell in which the CSI-ReportConfig is included, or to configure a semi-persistent or aperiodic report sent on PUSCH triggered by DCI received on the cell in which the CSI-ReportConfig is included (in this case, the cell on which the report is sent is determined by the received DCI). The CSI-ReportConfig comprises following fields:
reportConfigId field;
carrier field that comprises a ServCellIndex;
resourcesForChannelMeasurement field that comprises CSI-ResourceConfigId;
csi-IM-ResourcesForInterference field that comprises CSI-ResourceConfigId;
nzp-CSI-RS-ResourcesForInterference field that comprsies ResourceConfigId;
reportConfigType field that comprsies either periodic field (comprising parameters for report slot and pucch resource) or semiPersistentOnPUCCH field (comprising parameters for report slot and pucch resource);
reportQuantity field.

The IE LTM-CSI-ReportConfig is used to configure report on the cell in which the LTM-CSI-ReportConfig is included. The LTM-CSI-ReportConfig comprises following fields:
ltm-CSI-ReportConfigId field;
ltm-ResourcesForChannelMeasurement field that comprises LTM-CSI-ResourceConfigId;
ltm-ReportConfigType field that comprises either periodic field (comprising CSI-ReportPeriodicityAndOffset IE and one or more PUCCH-CSI-Resource IEs) or semiPersistentOnPUCCH-r18 field (comprising CSI-ReportPeriodicity AndOffset IE and one or more PUCCH-CSI-Resource IEs); and
ltm-ReportContent field that comprises noOfReportedCells field and noOfReportedRS-PerCell field.

The IE LTM-CSI-ResourceConfig defines a group of one or more CSI resources for an LTM candidate cell configuration. The LTM-CSI-ResourceConfig IE comprises following fields.
ltm-CSI-ResourceConfigId;
ltm-CSI-SSB-ResourseSetToAddModList field that comprises one or more LTM-CSI-SSB-ResourseSet; and
ltm-CSI-SSB-ResourseSetToReleaseList field that comprises one or more LTM-CSI-SSB-ResourseSetIds.

LTM-CSI-SSB-ResourceSet comprises following fields:
ltm-CSI-SSB-ResourceSetId field;
ltm-CandidateId field; and
ltm-CSI-SSB-ResourceList field that comprises one or more SSB-Index.

Each SSB-Index in the LTM-CSI-SSB-ResourceSet IE is associated with ltm-CandidateId indicated by the ltm-CandidateId field.

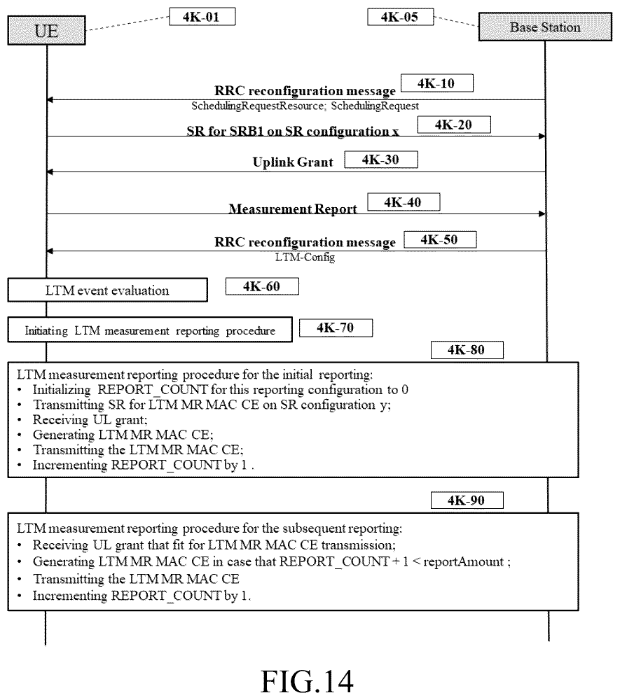

FIG. 14 illustrates the overall operations of UE and GNB.

LTM candidate cell and candidate cell are used interchangeably.

Beam and reference signal are used interchangeably.

At 4K-10:
>1: UE (4K-01) receives from the base station (4K-05) a first RRC reconfiguration message, wherein the first RRC reconfiguration message comprises following fields/IEs.
   >>2: RRCReconfiguration/CellGroupConfig/spCellConfig/ServingCellConfig/uplinkConfig/BWP-Uplink/BWP-UplinkDedicated/PUCCH-Config/schedulingRequestResourceToAddModList

| | |
|---|---|
| SchedulingRequestResourceConfig ::= | SEQUENCE { |

schedulingRequestResourceId
SchedulingRequestResourceId,

| | |
|---|---|
| schedulingRequestID | SchedulingRequestId, |
| periodicityAndOffset | CHOICE { |
| sym2 | NULL, |
| sym6or7 | NULL, |
| sl1 | NULL, |

-- Recurs in every slot

| | |
|---|---|
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639) |

}
OPTIONAL, -- Need M

| | |
|---|---|
| resource | PUCCH-ResourceId |

OPTIONAL -- Need M
}

>>2: RRCReconfiguration/CellGroupConfig/spCellConfig/ServingCellConfig/uplinkConfig/BWP-Uplink/BWP-Uplink Dedicated/PUCCH-Config/SEQUENCE (SIZE (1 . . . maxNrofPUCCH-Resources)) OF PUCCH-Resource.

| | |
|---|---|
| PUCCH-Resource ::= | SEQUENCE { |
| pucch-ResourceId | PUCCH-ResourceId, |
| startingPRB | PRB-Id, |
| intraSlotFrequencyHopping | ENUMERATED { enabled } |

OPTIONAL, -- Need R

| | |
|---|---|
| secondHopPRB | PRB-Id |

OPTIONAL, -- Need R

| | |
|---|---|
| format | CHOICE { |
| format0 | PUCCH-format0, |
| format1 | PUCCH-format1, |
| format2 | PUCCH-format2, |
| format3 | PUCCH-format3, |
| format4 | PUCCH-format4 |

```
    }
  }
```

>>2: RRCReconfiguration/CellGroupConfig/MAC-CellGroupConfig/schedulingRequestConfig/schedulingRequestToAddModList.

| | |
|---|---|
| SchedulingRequestToAddMod ::= | SEQUENCE { |
| schedulingRequestId | SchedulingRequestId, |
| sr-ProhibitTimer | ENUMERATED {ms1, ms2, ms4, |
| ms8, ms16, ms32, ms64, ms128} | OPTIONAL, -- Need S |
| sr-TransMax | ENUMERATED { n4, n8, n16, |

n32, n64, spare3, spare2, spare1}
}

>>2: CellGroupConfig/RLC-BearerConfig/LogicalChannelConfig.

| | |
|---|---|
| LogicalChannelConfig ::= | SEQUENCE { |
| ul-SpecificParameters | SEQUENCE { |
| priority | INTEGER (1..16), |
| prioritisedBitRate | ENUMERATED {kBps0, |

kBps8, kBps16, kBps32, kBps64, kBps128, kBps256, kBps512,

kBps1024, kBps2048,

kBps4096, kBps8192, kBps16384, kBps32768, kBps65536, infinity},

| | |
|---|---|
| bucketSizeDuration | ENUMERATED {ms5, ms10, |

ms20, ms50, ms100, ms150, ms300, ms500, ms1000,

spare7,

spare6, spare5, spare4, spare3, spare2, spare1},

| | |
|---|---|
| allowedServingCells | SEQUENCE (SIZE |

(1..maxNrofServingCells-1)) OF ServCellIndex
OPTIONAL, -- Cond PDCP-CADuplication

| | |
|---|---|
| allowedSCS-List | SEQUENCE (SIZE |
| (1..maxSCSs)) OF SubcarrierSpacing | OPTIONAL, -- Need |

R

| | |
|---|---|
| maxPUSCH-Duration | ENUMERATED {ms0p02, |

ms0p04, ms0p0625, ms0p125, ms0p25, ms0p5, ms0p01-v1700, spare1}
OPTIONAL, -- Need R

| | |
|---|---|
| configuredGrantType1Allowed | ENUMERATED {true} |

OPTIONAL, -- Need R

| | |
|---|---|
| logicalChannelGroup | INTEGER (0..maxLCG-ID) |

OPTIONAL, -- Need R

| | |
|---|---|
| schedulingRequestID | schedulingRequestId |

OPTIONAL, -- Need R

| | |
|---|---|
| logicalChannelSR-Mask | BOOLEAN, |
| logicalChannelSR-DelayTimerApplied | BOOLEAN, |

...,

| | |
|---|---|
| bitRateQueryProhibitTimer | ENUMERATED {s0, s0dot4, |
| s0dot8, s1dot6, s3, s6, s12, s30} | OPTIONAL, -- Need R |

At 4K-20:
>1: UE triggers SR for SRB1 on SR configuration x (SR configuration associated with SRB1) and transmits SR based on SR configuration x.
   >>2: SR configuration x comprises a specific SchedulingRequestToAddMod (related to rule/restriction on SR transmission) and a specific PUCCH-Resource (related to frequency resource for SR transmission) and a specfiic SchedulingRequestResourceConfig (related to time resource for SR transmission).
      >>>3: The specific SchedulingRequestToAddMod is associated with SRB1 (e.g. LogicalChannelConfig of SRB1 comprises SchedulingRequestId corresponding to the specific SchedulingRequestToAddMod).
      >>>3: The specific SchedulingRequestResourceConfig is associated with the specific SchedulingRequestToAddMod (e.g. SchedulingRequestResourceConfig comprises SchedulingRequestId corresponding to the specific SchedulingRequestToAddMod)
      >>>3: The specific PUCCH-Resource is associated with the specific SchedulingRequestResourceConfig (e.g. SchedulingRequestResourceConfig comprises PUCCH-ResourceId corresponding to the specific PUCCH-Resource)
      >>>3: The SchedulingRequestResourceConfig provides the association information between the SchedulingRequestResourceConfig and the PUCCH-ResourceConfig and the SchedulingRequestToAddMod.

At 4K-30 and 4K-40:
>1: UE receives an uplink grant; and
>1: UE transmits measurement report message.

At 4K-50:
>1: The base station determines to configure LTM. The base station transmits RRC reconfiguration message. The message comprises LTM-Config. LTM-Config comprises one or more LTM-CSI-ResourceConfig IEs.

LTM-Config-r18 ::= SEQUENCE {

| | |
|---|---|
| ltm-ReferenceConfiguration-r18 | SetupRelease |
| {ReferenceConfiguration-r18} | OPTIONAL, -- |

Need M

| | |
|---|---|
| ltm-CandidateToReleaseList-r18 | SEQUENCE (SIZE |
| (1..maxNrofLTM-Configs-r18)) OF LTM-CandidateId-r18 | OPTIONAL, -- |

Need N

| | |
|---|---|
| ltm-CandidateToAddModList-r18 | SEQUENCE (SIZE |
| (1..maxNrofLTM-Configs-r18)) OF LTM-Candidate-r18 | OPTIONAL, -- |

Need N

| | |
|---|---|
| ltm-ServingCellNoResetID-r18 | INTEGER (1..maxNrofLTM- |
| Configs-plus1-r18) | OPTIONAL, -- Need N |
| ltm-CSI-ResourceConfigToAddModList-r18 | SEQUENCE (SIZE |
| (1..maxNrofLTM-CSI-ResourceConfigurations-r18)) | OF LTM-CSI- |

ResourceConfig-r18
OPTIONAL, -- Need N

| | |
|---|---|
| ltm-CSI-ResourceConfigToReleaseList-r18 | SEQUENCE (SIZE |
| (1..maxNrofLTM-CSI-ResourceConfigurations-r18)) | OF LTM-CSI- |

ResourceConfigId-r18
OPTIONAL, -- Need N

| | |
|---|---|
| attemptLTM-Switch-r18 | ENUMERATED {true} |

OPTIONAL, -- Cond LTM-MCG

| | |
|---|---|
| ltm-ServingCellUE-MeasuredTA-ID-r18 | INTEGER (1..maxNrofLTM- |
| Configs-plus1-r18) | OPTIONAL, -- Need N |

```
    ...
  }
```

>>2: LTM-CSI-ResourceConfig comprises following fields/IEs.

| | |
|---|---|
| LTM-CSI-ResourceConfig-r18 ::= | SEQUENCE { |
| ltm-CSI-ResourceConfigId-r18 | LTM-CSI-ResourceConfigId- |

r18,

| | |
|---|---|
| ltm-CSI-SSB-ResourceSet-r18 | LTM-CSI-SSB-ResourceSet- |

```
r18,
    ...
  }
```

| | |
|---|---|
| LTM-CSI-SSB-ResourceSet-r18 ::= | SEQUENCE { |
| ltm-CSI-SSB-ResourceList-r18 | SEQUENCE (SIZE |

(1..maxNrofLTM-CSI-SSB-ResourcesPerSet-r18)) OF SSB-Index,

| | |
|---|---|
| ltm-CandidateIdList-r18 | SEQUENCE (SIZE |

```
(1..maxNrofLTM-CSI-SSB-ResourcesPerSet-r18)) OF LTM-CandidateId-r18,
    ...
  }
```

>>>3: n-th entry of ltm-CSI-SSB-ResourceList and n-th entry of ltm-CandidateIdList are paired together to indicate a candidate beam (indicated by SSB-Index) of a candidate cell (indicted by LTM-CandidateId). Each pair in the LTM-CSI-SSB-ResourceSet is denoted by candidate beam indication.
>>>3: A candidate beam is either a serving cell beam or a neighbouring cell beam.
   >>>>4: a candidate beam indication for serving cell (serving cell beams) is associated with a specific LTM-CandidateId;
   >>>>4: a candidate beam indication for neighbour cell (neighbouring cell beams) is associated with a LTM-CandidateId that is different from the specific LTM-CandidateId;
>>>3: The specific LTM-CandidateId is characterized by:
   >>>>4: PCI (given by ltm-CandidatePCI) of the candidate cell associated with the specific LTM-CandidateId is equal to the PCI of the current SpCell; and
   >>>>4: frequency information (given by ssbFrequency) of the candidate cell associated with the specific LTM-CandidateId is equal to the center frequency of cell-defining SSB of the current SpCell.
>>2: Each LTM-Candidate comprises following fields/IEs.

| | |
|---|---|
| LTM-Candidate-r18 ::= | SEQUENCE { |
| ltm-CandidateId-r18 | LTM-CandidateId- |

r18,

| | |
|---|---|
| ltm-CandidatePCI-r18 | PhysCellId |

OPTIONAL, -- Need M

| | |
|---|---|
| ltm-SSB-Config-r18 | LTM-SSB-Config- |
| r18 | OPTIONAL, -- Need M |
| ltm-CandidateConfig-r18 | OCTET STRING |
| (CONTAINING RRCReconfiguration) | OPTIONAL, -- Need M |
| ltm-ConfigComplete-r18 | ENUMERATED |
| {true} | OPTIONAL, -- Need R |
| ltm-EarlyUL-SyncConfig-r18 | OCTET STRING |
| (CONTAINING EarlyUL-SyncConfig-r18) | OPTIONAL, -- Need R |
| ltm-EarlyUL-SyncConfigSUL-r18 | OCTET STRING |
| (CONTAINING EarlyUL-SyncConfig-r18) | OPTIONAL, -- Need R |
| ltm-TCI-Info-r18 | LTM-TCI-Info-r18 |

OPTIONAL, -- Need M

| | |
|---|---|
| ltm-NoResetID-r18 | INTEGER |
| (1..maxNrofLTM-Configs-plus1-r18) | OPTIONAL, -- Need M |
| ltm-UE-MeasuredTA-ID-r18 | INTEGER |
| (1..maxNrofLTM-Configs-plus1-r18) | OPTIONAL, -- Need M |

```
    ...
  }
  LTM-SSB-Config-r18 ::= SEQUENCE {
```

| | |
|---|---|
| ssb-Frequency-r18 | ARFCN-ValueNR, |

subcarrierSpacing-r18
SubcarrierSpacing,

| | |
|---|---|
| ssb-Periodicity-r18 | ENUMERATED {ms5, |

ms10, ms20, ms40, ms80, ms160, spare2, spare1} OPTIONAL, -- Need R

| | |
|---|---|
| ssb-PositionsInBurst-r18 | CHOICE { |
| shortBitmap | BIT STRING |

(SIZE (4)),

| | |
|---|---|
| mediumBitmap | BIT STRING |

(SIZE (8)),

| | |
|---|---|
| longBitmap | BIT STRING |

(SIZE (64))
}
OPTIONAL, -- Need R

| | |
|---|---|
| ss-PBCH-BlockPower-r18 | INTEGER (− |
| 60..50) | OPTIONAL, -- Need R |

```
    ...
  }
```

>>>3: ltm-CandidateConfig/RRCReconfiguration may comprise LTM-CSI-EventReportConfig-r19.
   >>>>4: RRCReconfiguration/CellGroupConfig/spCellConfigDedicated;ServingCellConfig/CSI-MeasConfig/SEQUENCE (SIZE (1 . . . maxNrofXXX)) OF LTM-CSI-EventReportConfig-r19.

| | |
|---|---|
| LTM-CSI-EventReportConfig-r19 ::= | SEQUENCE { |
| ltm-CSI-EventReportConfigId-r19 | LTM-CSI- |

EventReportConfigId-r19,

| | |
|---|---|
| ltm-ResourcesForChannelMeasurement-r18 | LTM-CSI- |

ResourceConfigId-r18,

| | |
|---|---|
| ltm-EventReportConfigType-r19 | CHOICE |

{

| | |
|---|---|
| eventId | CHOICE { |
| eventLTM2 | SEQUENCE { |

ltm2-Threshold
MeasTriggerQuantity,

| | |
|---|---|
| reportOnLeave | BOOLEAN, |
| hysteresis | Hysteresis, |

```
            timeToTrigger
TimeToTrigger
              beamToConsider
              ENUMERATED {best, worst}, OPTOINAL
        },
```

| | |
|---|---|
| eventLTM3 | SEQUENCE { |

ltm3-Offset
MeasTriggerQuantityOffset,

| | |
|---|---|
| reportOnLeave | BOOLEAN, |
| hysteresis | Hysteresis, |

```
            timeToTrigger
TimeToTrigger,
              servingBeamToConsider
                ENUMERATED {best, worst}, OPTINOAL
              candidateBeamToConsider
                ENUMERATED {best, worst}, OPTIONAL
        },
```

| | |
|---|---|
| eventLTM4 | SEQUENCE { |

ltm4-Threshold
MeasTriggerQuantity,

| | |
|---|---|
| reportOnLeave | BOOLEAN, |
| hysteresis | Hysteresis, |

```
            timeToTrigger
TimeToTrigger,
              candidateBeamToConsider
                ENUMERATED {best, worst}, OPTIONAL
        },
```

| | |
|---|---|
| eventLTM5 | SEQUENCE { |

```
            ltm5-Threshold1
MeasTriggerQuantity,
            ltm5-Threshold2
MeasTriggerQuantity,
```

| | |
|---|---|
| reportOnLeave | BOOLEAN, |
| hysteresis | Hysteresis, |

```
            timeToTrigger
TimeToTrigger,
              servingBeamToConsider
                ENUMERATED {best, worst}, OPTINOAL
              candidateBeamToConsider
                ENUMERATED {best, worst}, OPTIONAL
        },
```

| | |
|---|---|
| reportInterval | ReportInterval, |
| reportAmount | ENUMERATED {r1, r2, |

r4, r8, r16, r32, r64, infinity},

| | |
|---|---|
| maxReportBeams | INTEGER |

```
(1..maxBeamReport),
  eventId: Type of LTM event for triggering event-triggered measurement
report.
  hysteresis: Hysteresis when evaluating the entering/leaving
conditions for an LTM event.
  ltm-ResourcesForChannelMeasurement: This field indicates the index
of SSB or CSI-RS in the field LTM-CSI-ResourceConfig.
  ltm2-Threshold, ltm4-Threshold, ltm5-Threshold1, ltm5-Threshold2:
Thresholds defined in the entering/leaving conditions for different LTM
events.
  ltm3-Offset: Offset for the entering/leaving condition for event LTM3.
The actual value is field value * 0.5 dB.
  reportOnLeave: Indicates whether the event-triggered measurement
report by MAC CE shall be triggered when leaving condition is satisfied.
  maxReportBeams: This field defines maximum number of beams whose
measurements can be reported in the event-triggered measurement report by
MAC CE.
  reportInterval: This field defines the periodicity of the event-
triggered periodic measurement report.
  reportAmount: Number of measurement reports needs to be transmitted
after the event is triggered Value ′r2′ means the report is sent twice, ’r3’
means the report is sent three times, and so on.
  MeasTriggerQuantity is Measurement quantity defined in the
measurement report configurations (e.g., events defined in ReportConfig-
NR, or LTM-CSI-ReportConfig) for triggering measurement reports (e.g., by
RRC message MeasurementReport or by MAC CE).
```

| | |
|---|---|
| MeasTriggerQuantity ::= | CHOICE { |
| rsrp | RSRP-Range, |
| rsrq | RSRQ-Range, |
| sinr | SINR-Range |

```
  }
  MeasTriggerQuantityOffset is Offsets defined in measurement report
configurations (e.g., events defined in ReportConfig-NR, or LTM-CSI-
ReportConfig) for triggering measurement reports (e.g., by RRC message
MeasurementReport or by MAC CE). Values in the unit of ′dB′. When the IE
is configured under LTM-CSI-ReportConfig, only the field rsrp is applicable.
```

| | |
|---|---|
| MeasTriggerQuantityOffset ::= | CHOICE { |
| rsrp | INTEGER (−30..30), |
| rsrq | INTEGER (−30..30), |
| sinr | INTEGER (−30..30) |

```
  }
  The IE RSRP-Range specifies the value range used in RSRP measurements
and thresholds. The actual value is (IE value − 156) dBm, except for the
IE value 127, in which case the actual value is infinity.
```

| | |
|---|---|
| RSRP-Range ::= | INTEGER(0..127) |

The IE Hysteresis is a parameter used within the entry and leave
condition of an event triggered reporting condition. The actual value is
field value * 0.5 dB.

| | |
|---|---|
| Hysteresis ::= | INTEGER (0..30) |

>1: UE configures an event based on each of the LTM-CSI-EventReportConfig-r19.
   >>2: Event LTM2 is characterized as below.
      >>>3: A specific beam of serving cell becomes worse than absolute threshold (ltm2-Threshold).
      >>>3: The specific beam of serving cell is the best beam or worst beam or any beam of the serving cell (best or worst in case that beamToConsider field is present; any serving beam in case that beamToConsider field is absent).
      >>>3: the SSB resources/indexs in ltm-CSI-SSB-ResourceList is beam of serving cell in case that:
         >>>>4: PCI (given by ltm-CandidatePCI) of the candidate cell associated with the LTM-CandidateId (given by the corresponding entry in ltm-CandidateIdList) is equal to the PCI of the current SpCell; and
         >>>>4: frequency information (given by ssbFrequency) of the candidate cell associated with the LTM-CandidateId (given by the corresponding entry in ltm-CandidateIdList) is equal to the center frequency of cell-defining SSB of the current SpCell.
   >>2: Event LTM3 is characterized as below.
      >>>3: A specific beam of candidate cell becomes amount of offset (ltm3-Offset) better than a specific beam of serving cell.
      >>>3: The specific beam of serving cell is the best beam or worst beam or any beam of the serving cell (best or worst in case that servingBeamToConsider field is present; any serving beam in case that servingBeamToConsider field is absent).
      >>>3: The specific beam of candidate cell is the best beam or worst beam or any beam of a candidate cell (best or worst in case that candidateBeamToConsider field is present; any candidate beam of any candidate cell in case that candidateBeamToConsider field is absent).
   >>2: Event LTM4 is characterized as below.
      >>>3: A specific beam of candidate cell becomes better than absolute threshold.
      >>>3: The specific beam of candidate cell is the best beam or worst beam or any beam of a candidate cell (best or worst in case that candidateBeamToConsider field is present; any candidate beam of any candidate cell in case that candidate BeamToConsider field is absent).
   >>2: Event LTM5 is characterized as below.
      >>>3: A specific beam of serving cell becomes worse than absolute threshold1 AND a specific beam of candidate cell becomes better than another absolute threshold2.

At 4K-60, UE performs LTM event evaluation.

At 4K-70, UE initiates LTM measurement reporting procedure in case that:
>1: the entry condition applicable for this event is fulfilled for one or more applicable beams for measurements taken during timeToTrigger defined for this event while the VarLtmMeasReportList does not include a measurement reporting entry for this LTM-CSI-EventReportConfig (e.g. while LTM measurement reporting procedure for this LTM-CSI-EventReportConfig is not ongoing/has not been triggered); or
>1: the leaving condition applicable for this event is fulfilled for one or more of the candidate/applicable beams included in the beamsTriggeredList defined within the VarLtmMeasReportList for this LTM-CSI-EventReportConfig for measurements taken during timeToTrigger defined for this event.
In this case, UE removes the one or more candidate/applicable beams from the beamsTriggeredList.

UE manages a beamsTriggeredList for a report configuration. UE creates the list for a report configuration when entering condition for the report configuration is fulfilled first time. UE release the list for the report configuration when the list is empty (due to leaving condition) or LTM-Config is released.

beamsTriggeredList includes the beam index (e.g. xxx) of candidate cell(s) for each report configuration, for which the L1 measurement report triggering conditions have been met for TTT.

For event LTMx, neighbouring cell beams and candidate cell beams are used interchangeably.

For Event LTM2 (A specific beam of serving cell becomes worse than absolute threshold),

The UE shall:
>1: consider the entering condition for this event to be satisfied when condition A2-1, as specified below, is fulfilled;
>1: consider the leaving condition for this event to be satisfied when condition A2-2, as specified below, is fulfilled;
>1: for this measurement, consider the serving cell beams indicated in LTM-CSI-ResourceConfig.

### Inequality A2-1 (Entering Condition)

Ms+Hys<Thresh

### Inequality A2-2 (Leaving Condition)

Ms−Hys>Thresh

The variables in the formula are defined as follows:
>1: Ms is the measurement result of, not taking into account any offsets:
   >>2: best/worst/any serving cell beam in case of A2-1; and
   >>2: the serving cell beam that has fulfilled the A2-1 in case of A2-2.
>1: Hys is the hysteresis parameter for this event.
>1: Thresh is the threshold parameter for this event.
>1: Ms is expressed in dBm.
>1: Hys is expressed in dB.
>1: Thresh is expressed in the same unit as Ms.
>1: Serving cell beams are applicable beams.

For Event LTM3 (Neighbour becomes offset better than SpCell),

The UE shall:
>1: consider the entering condition for this event to be satisfied when condition A3-1, as specified below, is fulfilled;
>1: consider the leaving condition for this event to be satisfied when condition A3-2, as specified below, is fulfilled;
>1: use the SpCell for Mp, Ofp and Ocp.

### Inequality A3-1 (Entering Condition)

Mn−Hys>Ms+Off

### Inequality A3-2 (Leaving Condition)

Mn+Hys<Mp+Off

The variables in the formula are defined as follows:
>1: Mn is the measurement result not taking into account any offsets:
   >>2: best/worst/any neighbouring cell beam in case of A3-1; and
   >>2: the neighbouring cell beam that has fulfilled the A3-1 in case of A3-2.
>1: Ms is the measurement result of, not taking into account any offsets:
   >>2: best/worst/any serving cell beam in case of A3-1; and
   >>2: the serving cell beam that has fulfilled the A3-1 in case of A3-2.
>1: Ms is the measurement result of the SpCell, not taking into account any offsets.
>1: Hys is the hysteresis parameter for this event.
>1: Off is the offset parameter for this event.
>1: Serving cell beams and neighbouring cell beams are applicable beams.

For Event LTM4 (Neighbour cell beam becomes better than threshold), The UE shall:
>1: consider the entering condition for this event to be satisfied when condition A4-1, as specified below, is fulfilled;
>1: consider the leaving condition for this event to be satisfied when condition A4-2, as specified below, is fulfilled.

### Inequality A4-1 (Entering Condition)

Mn−Hys>Thresh

### Inequality A4-2 (Leaving Condition)

Mn+Hys<Thresh

The variables in the formula are defined as follows:
>1: Mn is the measurement result not taking into account any offsets:
   >>2: best/worst/any neighbouring cell beam in case of A4-1; and
   >>2: the neighbouring cell beam that has fulfilled the A4-1 in case of A4-2.
>1: neighbouring cell beams are applicable beams.

For Event LTM5 (Serving cell beam becomes worse than threshold1 and neighbour cell beam becomes better than threshold2),

The UE shall:
>1: consider the entering condition for this event to be satisfied when both condition A5-1 and condition A5-2, as specified below, are fulfilled; and
>1: consider the leaving condition for this event to be satisfied when condition A5-3 or condition A5-4, i.e. at least one of the two, as specified below, is fulfilled.

### Inequality A5-1 (Entering Condition 1)

Ms+Hys<Thresh1

### Inequality A5-2 (Entering Condition 2)

Mn−Hys>Thresh2

### Inequality A5-3 (Leaving Condition 1)

Ms−Hys>Thresh1

### Inequality A5-4 (Leaving Condition 2)

MnHys<Thresh2

The variables in the formula are defined as follows:
>1: Mn is the measurement result not taking into account any offsets:
   >>2: best/worst/any neighbouring cell beam in case of A5-2; and
   >>2: the neighbouring cell beam that has fulfilled the A5-2 in case of A5-4.
>1: Ms is the measurement result of, not taking into account any offsets:
   >>2: best/worst/any serving cell beam in case of A5-1; and
   >>2: the serving cell beam that has fulfilled the A5-1 in case of A5-3.
>1: Serving cell beams and neighbouring cell beams are applicable beams.

When LTM MR reporting procedure is initiated for a LTM MR report configuration (e.g. for a LTM-CSI-EventReportConfigId), UE performs initial reporting at 4K-80 and one or more subsequent reporting at 4K-90. Subsequent reporting is performed periodically. The periodicity is determined based on reportInterval. number of subsequent reporting is determined based on reportAmount.

UE does not trigger LTM MR report for a LTM MR report configuration in case that LTM MR procedure for the same LTM MR report configuration is on-going (e.g. either initial transmission or subsequent transmissions are on-going for the same LTM MR report configuration).

LTM MR report contains layer 1 measurement result (e.g. CSI result). LTM MR report can be layer 1 measurements report MAC CE.

At 4K-80, UE performs LTM measurement reporting procedure for initial reporting as below.

UE generates a LTM MR MAC CE in case that UL-SCH resources are available for a new transmission and these UL-SCH resources can accommodate the LTM MR MAC CE plus its subheader as a result of logical channel prioritization.

UE triggers a Scheduling Request for LTM MR MAC CE that is generated for initial/first reporting in case that:
UL-SCH resources are available for a new transmission and these UL-SCH resources can not accommodate the LTM MR MAC CE plus its subheader as a result of logical channel prioritization; or
>: UL-SCH resources are not available for a new transmission.

UE does not trigger SR for LTM MR MAC CE in case that the LTM MR MAC CE is generated for subsequent reporting (e.g. periodical reporting).

If UE determines to trigger the SR for LTM MR MAC CE, UE performs followings.
>1: UE triggers SR for LTM MR MAC CE on SR configuration y (SR configuration associated with (or dedicated to) LTM MR MAC CE) and transmits SR based on SR configuration y.
   >>2: SR configuration y comprises a specific SchedulingRequestToAddMod and a specific PUCCH-Resource and a specfiic SchedulingRequestResourceConfig.
      >>>3: The specific SchedulingRequestToAddMod is associated with LTM MR MAC CE (e.g. MAC-CellGroupConfig comprises a specific field comprising a SchedulingRequestId, wherein the specific field indicates SchedulingRequestID for LTM MAC CE transmission).
      >>>3: The specific SchedulingRequestResourceConfig is associated with the specific SchedulingRequestToAddMod (e.g. SchedulingRequestResourceConfig comprises SchedulingRequestId corresponding to the specific SchedulingRequestToAddMod)
      >>>3: The specific PUCCH-Resource is associated with the specific SchedulingRequestResourceConfig (e.g. SchedulingRequestResourceConfig comprises PUCCH-ResourceId corresponding to the specific PUCCH-Resource).

Alternatively, UE triggers SR for LTM MR MAC CE on a SR configuration that is configured for other purpose. For example, since SRB1 is used for RRC MR reporting, SR configuration for SRB1 can implicitly be used for LTM MR MAC CE transmission as well. UE transmits SR on time/frequency resource identified based on the specific PUCCH-Resource and the specific SchedulingRequestResourceConfig.

UE receives an uplink grant in response to the SR.

UE generates an LTM MR MAC CE. The LTM MR MAC CE comprises measurement results on plurality of beams.

LTM MR MAC CE 4L-10 comprises following fields:
>1: COUNT field indicates some of followings:
   >>2: whether it is for initial/first/fresh reporting or for subsequent reporting;
   >>2: number of times it has been reported, in case that number of reporting is smaller than a specific value (e.g. 7); and
   >>2: it has been reported more than the specific value in case that number of reporting is equal to or greater than the specific value . . .
   >>2:000 indicates initial/first/fresh reporting; 001 indicates first subsequent reporting (e.g. it has been transmitted two times), . . . 110 indicates 6-th subsequent reporting; 111 indicates it has been transmitted more than 7 times.
>1: RepId field indicates the LTM-CSI-EventReportConfigId that triggers the LTM MR (reporting procedure);
>1: L/E field indicates whether the LTM MR is triggered by entering condition or leaving condition. If it is set to 0, the LTM MR (reporting procedure) is triggered by entering condition.
>1: one or more pairs of Resource indicator field and RSRP
   >>2: Resource Indicator field indicates the CSI-RS/SSB resource for which RSRP is reported. Resource Indicator is a composite identifier associated with a specific candidate cell and a specific SSB-Resource.
      >>>3: Resource Indicator #n indicates the n-th entry of ltm-CSI-SSB-ResourceList and n-th entry of ltm-CandidateIdList (e.g. Resource Indicator #n indicates that RSRP of n-th candidate beam indication follows).
   >>2: RSRP field comprises measured result of the beam. It is average value of all measurement results taken during timeToTrigger.

UE includes maxReportBeams entries of Resource Indicator/RSRP pair in the LTM MR MAC CE.

UE includes Resource Indicator/RSRP pair in the order of RSRP (e.g. highest RSRP goes first).

UE transmits the LTM MR MAC CE. UE increment the REPORT_COUNT variable by one. REPORT_COUNT stores/holds number of LTM MR MAC CE transmission (LTM MR reporting)

UE performs LTM MR procedure for subsequent reporting 4K-90.

UE generates LTM MR MAC CE when an uplink grant is received, in case that:
ReportInterval has been elapsed since the last transmission of LTM MR MAC CE for the same report configuration;
REPORT_COUNT is less than reportAmount−1; and
UL-SCH resources (indicated in the uplink grant) are available for a new transmission and these UL-SCH resources can accommodate the LTM MR MAC CE plus its subheader as a result of logical channel prioritization.

UE transmits the LTM MR MAC CE.

For initial transmission and subsequent transmission, UE sets the fields in the LTM MR MAC CE:
>1: COUNT field is set to a value indicating the number of reporting (or indicating number of reporting exceed a specific value);
>1: RepId field is set to the the LTM-CSI-EventReportConfigId that has triggered the current LTM MR (reporting procedure);
>1: L/E field is set to a value depending on whether the it is related to entering condition or to leaving condition.
>1: UE determines the pairs of Resource indicator field and RSRP to be included in the MAC CE.
   >>2: for initial reporting/transmission, maxReportBeams entries of Resource Indicator/RSRP pair from the highest RSRP to maxReportBeams-th RSRP in descending order of the RSRP;
   >>2: for subsequent reporting/transmission, those pairs that have been reported in the previous/initial reporting (or essential pairs regardless of RSRP and remaining pairs from the highest RSRP).

UE transmits the LTM MR MAC CE. UE increment the REPORT_COUNT variable by one. REPORT_COUNT stores/holds number of LTM MR MAC CE transmission (LTM MR reporting).

When REPORT_COUNT is equal to reportAmount−1, UE finishes the LTM MR reporting procedure for the LTM reporting configuration. UE release/deletes beamsTriggeredList.

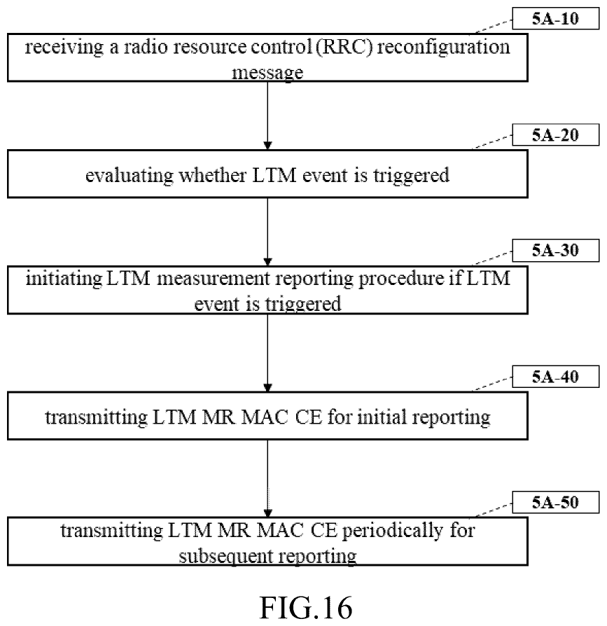

FIG. 16 is a flow diagram illustrating an operation of UE.

At 5A-10, the terminal receives from base station RRCReconfiguration message. The message comprises various parameters for LTM such as LTM event configurations.

At 5A-20, the terminal evaluates whether LTM event is triggered.

At 5A-30, the terminal initiates LTM measurement reporting procedure if LTM event is triggered.

At 5A-40, the terminal transmits LTM MR MAC CE for initial reporting.

At 5A-50, the terminal transmits periodically LTM MR MAC CEs for subsequent reporting. Subsequent reporting is performed periodically.

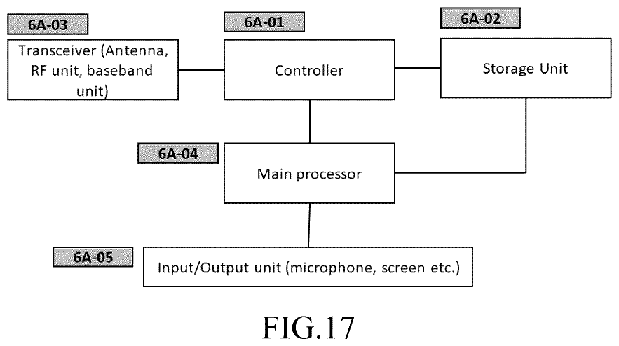

FIG. 17 is a block diagram illustrating the internal structure of a UE to which the disclosure is applied.

Referring to the diagram, the UE includes a controller 6A-01, a storage unit 6A-02, a transceiver 6A-03, a main processor 6A-04 and I/O unit 6A-05.

The controller 6A-01 controls the overall operations of the UE in terms of mobile communication. For example, the controller 6A-01 receives/transmits signals through the transceiver 6A-03. In addition, the controller 6A-01 records and reads data in the storage unit 6A-02. To this end, the controller 6A-01 includes at least one processor. For example, the controller 6A-01 may include a communication processor (CP) that performs control for communication and an application processor (AP) that controls the upper layer, such as an application program. The controller controls storage unit and transceiver such that UE operations illustrated in the present disclosure are performed.

The storage unit 6A-02 stores data for operation of the UE, such as a basic program, an application program, and configuration information. The storage unit 6A-02 provides stored data at a request of the controller 6A-01.

The transceiver 6A-03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor 6A-04 controls the overall operations other than mobile operation. The main processor 6A-04 process user input received from I/O unit 6A-05, stores data in the storage unit 6A-02, controls the controller 6A-01 for required mobile communication operations and forward user data to I/O unit 6A-05.

I/O unit 6A-05 consists of equipment for inputting user data and for outputting user data such as a microphone and a screen. I/O unit 6A-05 performs inputting and outputting user data based on the main processor's instruction.

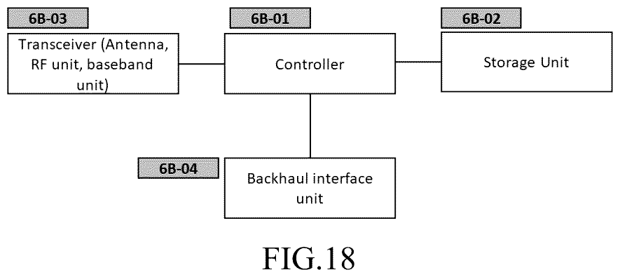

FIG. 18 is a block diagram illustrating the configuration of a base station according to the disclosure.

As illustrated in the diagram, the base station includes a controller 6B-01, a storage unit 6B-02, a transceiver 6B-03 and a backhaul interface unit 6B-04.

The controller 6B-01 controls the overall operations of the main base station. For example, the controller 6B-01 receives/transmits signals through the transceiver 6B-03, or through the backhaul interface unit 6B-04. In addition, the controller 6B-01 records and reads data in the storage unit 6B-02. To this end, the controller 6B-01 may include at least one processor. The controller controls transceiver, storage unit and backhaul interface such that base station operation illustrated in the present disclosure are performed.

The storage unit 6B-02 stores data for operation of the main base station, such as a basic program, an application program, and configuration information. Particularly, the storage unit 6B-02 may store information regarding a bearer allocated to an accessed UE, a measurement result reported from the accessed UE, and the like. In addition, the storage unit 6B-02 may store information serving as a criterion to determine whether to provide the UE with multi-connection or to discontinue the same. In addition, the storage unit 6B-02 provides stored data at a request of the controller 6B-01.

The transceiver 6B-03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit 6B-04 provides an interface for communicating with other nodes inside the network. The backhaul interface unit 6B-04 converts a bit string transmitted from the base station to another node, for example, another base station or a core network, into a physical signal, and converts a physical signal received from the other node into a bit string.

What is claimed is:

1. A method performed by a terminal, the method comprising:
receiving from a base station a layer 3 control message, wherein the layer 3 control message comprises a Channel State Information (CSI) report configuration parameter, wherein the CSI report configuration parameter comprises:
information related to a CSI report configuration identifier;
information related to the number of layer 2 control messages;
information related to specific time duration;
information related to an L1/L2 Triggered Mobility (LTM) event; and
information related to offset specific to the LTM event; and
generating a specific number of layer 2 control messages based on a condition specific to the LTM event being fulfilled during the specific time duration for a specific beam that is included in a list of triggered beams associated with a CSI report configuration,
wherein:
the specific beam is associated with a specific candidate cell;
the specific time duration is determined based on the information related to specific time duration;
the condition is determined based on the information related to offset specific to the LTM event; and
each of the specific number of layer 2 control messages comprises the CSI report configuration identifier and one or more pairs of a beam index and measured result of beam.

2. The method of claim 1, wherein:
the specific number is determined based on the information related to the number of layer 2 control messages; and
the specific number of the layer 2 control messages are transmitted in sequence.

3. The method of claim 1,
wherein the list of triggered beams associated with the LTM report configuration includes beam index of candidate cell for which layer 1 measurement report triggering conditions have been met for the specific time duration.

4. The method of claim 1,
wherein the list of triggered beams is released in case that the list of triggered beams becomes empty.

5. A terminal in a wireless communication system, terminal comprising:
a transceiver,
a memory, and
a controller coupled to the transceiver and the memory, wherein the controller is configured to cause the terminal to:
receive from a base station a layer 3 control message, wherein the layer 3 control message comprises a Channel State Information (CSI) report configuration parameter, wherein the CSI report configuration parameter comprises:
information related to a CSI report configuration identifier;
information related to the number of layer 2 control messages;
information related to specific time duration;
information related to an L1/L2 Triggered Mobility (LTM) event; and
information related to offset specific to the LTM event, and
generate a specific number of layer 2 control messages based on a condition specific to the LTM event being fulfilled during the specific time duration for a specific beam that is included in a list of triggered beams associated with a CSI report configuration,
wherein:
the specific beam is associated with a specific candidate cell;
the specific time duration is determined based on the information related to specific time duration;
the condition is determined based on the information related to offset specific to the LTM event; and
each of the specific number of layer 2 control messages comprises the CSI report configuration identifier and one or more pair of a beam index and measured result of beam.
